(19) United States
(12) Patent Application Publication
(10) Pub. No.: US 2015/0264356 A1
(43) Pub. Date: Sep. 17, 2015

(54) Method of Simplified Depth Based Block Partitioning

(71) Applicant: MediaTek Singapore Pte. Ltd., Singapore (SG)

(72) Inventors: Xianguo ZHANG, Beijing (CN); Jian-Liang LIN, Su'ao Township, (TW); Kai ZHANG, Beijing (CN); Jicheng AN, Beijing City (CN); Han HUANG, Beijing (CN)

(21) Appl. No.: 14/640,108

(22) Filed: Mar. 6, 2015

(30) Foreign Application Priority Data
Mar. 13, 2014 (CN) PCT/CN2014/073360

(51) Int. Cl. H04N 19/136; H04N 19/50; H04N 19/176

(52) U.S. Cl. CPC H04N 19/136; H04N 19/176; H04N 19/50

(57) ABSTRACT

A method of simplified depth-based block partitioning (DBBP) for three-dimensional and multi-view video coding is disclosed. In one embodiment, a selected set of partition candidates is determined from one or more sets of the partition candidates including at least one partial set of the partition candidate consisting of less than full-set partition candidates. The one or more sets of the partition candidates may correspond to only one simplified set consisting of 2N×N and N×2N block partitions and there is no need to signal the selected set of partition candidates. In another embodiment of the present invention, the depth-based block partitioning (DBBP) coding is applied to a current block only if the current block size belongs to a set of allowed block sizes. The set of allowed block sizes can be pre-defined and no explicit signaled is needed.

### CROSS REFERENCE TO RELATED APPLICATIONS

The present invention claims priority to PCT Patent Application, Serial No. PCT/CN2014/073360, filed on Mar. 13, 2014, entitled “A Simplified Depth-based Block Partitioning Method”. The PCT Patent Application is hereby incorporated by reference in its entirety.

### FIELD OF THE INVENTION

The present invention relates to three-dimensional (3D) and multi-view video coding. In particular, the present invention relates to texture coding utilizing simplified depth-based block partitioning (DBBP).

### BACKGROUND AND RELATED ART

Three-dimensional (3D) television has been a technology trend in recent years that intends to bring viewers sensational viewing experience. Various technologies have been developed to enable 3D viewing. Among them, the multi-view video is a key technology for 3DTV application among others. The traditional video is a two-dimensional (2D) medium that only provides viewers a single view of a scene from the perspective of the camera. However, the 3D video is capable of offering arbitrary viewpoints of dynamic scenes and provides viewers the sensation of realism.

The 3D video is typically created by capturing a scene using video camera with an associated device to capture depth information or using multiple cameras simultaneously, where the multiple cameras are properly located so that each camera captures the scene from one viewpoint. The texture data and the depth data corresponding to a scene usually exhibit substantial correlation. Therefore, the depth information can be used to improve coding efficiency or reduce processing complexity for texture data, and vice versa. For example, the corresponding depth block of a texture block reveals similar information corresponding to the pixel level object segmentation. Therefore, the depth information can help to realize pixel-level segment-based motion compensation. Accordingly, a depth-based block partitioning (DBBP) has been adopted for texture video coding in the current 3D-HEVC (3D video coding based on the High Efficiency Video Coding (HEVC) standard).

The current depth-based block partitioning (DBBP) comprises steps of virtual depth derivation, block segmentation, block partition, and bi-segment compensation. First, virtual depth is derived for the current texture block using a disparity vector from neighboring blocks (NBDV). The derived disparity vector (DV) is used to locate a depth block in a reference view from the location of the current texture block. The reference view may be a base view. The located depth block in the reference view is then used as a virtual depth block for coding the current texture block. The virtual depth block is to derive block segmentation for the collocated texture block, where the block segmentation can be non-rectangular. A mean value, d̅ of the virtual depth block is determined. A binary segmentation mask is generated for each pixel of the block by comparing the virtual depth value with the mean value d̅. FIGS. 1A-B illustrates an example of block segmentation based on the virtual block. In FIG. 1A, corresponding depth block 120 in a reference view for current texture block 110 in a dependent view is located based on the location of the current texture block and derived DV 112, which is derived using NBDV according to 3D-HEVC. The mean value of the virtual block is determined in step 140. The values of virtual depth samples are compared to the mean depth value in step 150 to generate segmentation mask 160. The segmentation mask is represented in binary data to indicate whether an underlying pixel belongs to segment 1 or segment 2, as indicated by two different line patterns in FIG. 1B.

In order to avoid high computational complexity associated with pixel-based motion compensation, DBBP uses block-based motion compensation. Each texture block may use one of 6 non-square partitions consisting of 2N×N, N×2N, 2N×nU, 2N×nD, nL×2N and nR×2N, where the latter four block partitions correspond to AMP (asymmetric motion partition). After a block partition is selected from these block-partition candidates by block partition selection process, two predictive motion vectors (PMVs) are derived for the partitioned blocks respectively. The PMVs are then utilized for compensating the to-be-divided two segments. According to the current 3D-HEVC, the best block partition is selected by comparing the segmentation mask and the negation of the segmentation mask (i.e., the inverted segmentation mask) with the 6 non-square partition candidates (i.e., 2N×N, N×2N, 2N×nU, 2N×nD, nL×2N and nR×2N). The pixel-by-pixel comparison counts the number of so-called matched pixels between the segmentation masks and the block partition patterns. There are 12 sets of matched pixels need to be counted, which correspond to the combinations of 2 complementary segmentation masks and 6 block partition types. The block partition process selects the candidate having the largest number of matched pixels. FIG. 2 illustrates an example of block partition selection process. In FIG. 2, the 6 non-square block partition types are superposed on top of the segmentation mask and the corresponding inverted segmentation mask. A best matching partition between a block partition type and a segmentation mask is selected as the block partition for the DBBP process.

After a block partition type is selected, two predictive motion vectors can be determined. Each of the two predictive motion vectors is applied to the whole block to form a corresponding prediction block. The two prediction blocks are then merged into one on a pixel by pixel basis according to the segmentation mask and this process is referred as bi-segment compensation. FIG. 3 illustrates an example of DBBP process. In this example, the N×2N block partition type is selected and two corresponding motion vectors (MV1 and MV2) are derived for two partitioned blocks respectively. Each of the motion vectors is used to compensate a whole texture block (310). Accordingly, motion vector MV1 is applied to texture block 320 to generate prediction block 330 according to motion vector MV1, and motion vector MV2 is also applied to texture block 320 to generate prediction block 332 according to motion vector MV2. The two prediction blocks are merged by applying respective segmentation masks (340 and 342) to generate the final prediction block (350).

While the DBBP process reduces computational complexity by avoiding pixel-by-pixel based motion compensation, problems still exist in the steps of block partition and block segmentation. One issue is associated with the selection of block partition among the set of block partition candidates. As shown in FIG. 2, the current block partition process has to select a block partition among 6 block partition candidates and two complementary segmentation masks for each block partition candidate. It is desirable to simplify to block partition process. Another issue is related to computational complexity and memory access associated with the DBBP process. For each 2N×2N texture block to be processed, the corresponding depth block has to be accessed. The current texture block has to be accessed twice for motion compensation based on two PMVs. The block segmentation process, block partition process and the bi-segmentation compensation process all involve intensive computations. When the block size gets smaller, the picture will be divided into more blocks and leads to more memory access. Therefore, it is desirable to reduce the complexity and memory access associated with DBBP.

### BRIEF SUMMARY OF THE INVENTION

A method of simplified depth-based block partitioning (DBBP) for three-dimensional and multi-view video coding is disclosed. In one embodiment, a selected set of partition candidates is determined from one or more sets of the partition candidates including at least one partial set of the partition candidate consisting of less than full-set partition candidates. The full-set partition candidates consist of 2N×N, N×2N, 2N×nU, 2N×nD, nL×2N and nR×2N block partitions. The one or more sets of the partition candidates may correspond to only one simplified set consisting of 2N×N and N×2N block partitions and there is no need to signal the selected set of partition candidates. The one simplified set consisting of 2N×N and N×2N may also be one of said one or more sets of the partition candidates. Said one or more sets of the partition candidates can be pre-defined and each of said one or more sets is indicated by an index. The index for the selected set can be signaled explicitly in VPS (video parameter set), SPS (sequence parameter set), PPS (picture parameter set), Slice header, CTU (Coding Tree Unit), CTB (Coding Tree Block), CU (coding unit), PU (prediction unit) or TU (transform unit) level of bitstream. Alternatively, the selected set of partition candidates can be signaled explicitly in VPS (video parameter set), SPS (sequence parameter set), PPS (picture parameter set), Slice header, CTU (Coding Tree Unit), CTB (Coding Tree Block), CU (coding unit), PU (prediction unit) or TU (transform unit) level of bitstream. In this case, the selected set of partition candidates can be represented using a significant map, a significant table or significant flags.

The selected set of partition candidates may exclude any partition candidate from 2N×nU, 2N×nD, nL×2N and nR×2N partition candidates if a current block size belongs to a set of allowed block sizes. The set of allowed block sizes can be signaled using a significant map, a significant table or significant flags in VPS (video parameter set), SPS (sequence parameter set), PPS (picture parameter set), Slice header, CTU (Coding Tree Unit), CTB (Coding Tree Block), CU (coding unit), PU (prediction unit) or TU (transform unit) level of bitstream. The set of allowed block sizes can also be pre-defined and there is no need to signal the block size set explicitly.

In another embodiment of the present invention, the depth-based block partitioning (DBBP) coding is applied to a current block only if the current block size belongs to a set of allowed block sizes. The set of allowed block sizes can be pre-defined and no explicit signaled is needed. The set of allowed block sizes can also be signaled explicitly in VPS (video parameter set), SPS (sequence parameter set), PPS (picture parameter set), Slice header, CTU (Coding Tree Unit), CTB (Coding Tree Block), CU (coding unit), PU (prediction unit) or TU (transform unit) level of bitstream. In this case, the set of allowed block sizes can be represented using a significant map, a significant table or significant flags. The set of allowed block sizes may consist of all N×N block sizes, wherein N is greater than a positive integer M., where N can be signaled explicitly or is pre-defined. In one example, M is chosen to be 8.

### BRIEF DESCRIPTION OF THE DRAWINGS

FIG. 1A illustrates an exemplary derivation process to derive a corresponding depth block in a reference view for a current texture block in a dependent view.

FIG. 1B illustrates an exemplary derivation process to generate the segmentation mask based on the corresponding depth block in a reference view for a current texture block in a dependent view.

FIG. 2 illustrates an example of 12 possible combinations of block partition types and segmentation mask/inverted segmentation mask for block partition selection.

FIG. 3 illustrates an exemplary processing flow for 3D or multi-view coding using depth-based block partitioning (DBBP).

FIG. 4 illustrates an example of simplified depth-based block partitioning (DBBP) using partial partition candidates consisting of 2N×N and N×2N partition candidates.

FIG. 5 illustrates a flowchart of an exemplary system incorporating an embodiment of the present invention to simplify depth-based block partitioning (DBBP), where a partial set of partition candidates is used.

FIG. 6 illustrates a flowchart of an exemplary system incorporating an embodiment of the present invention to simplify depth-based block partitioning (DBBP), where the DBBP process is applied to a block only if the block size belongs to a set of allowed block sizes.

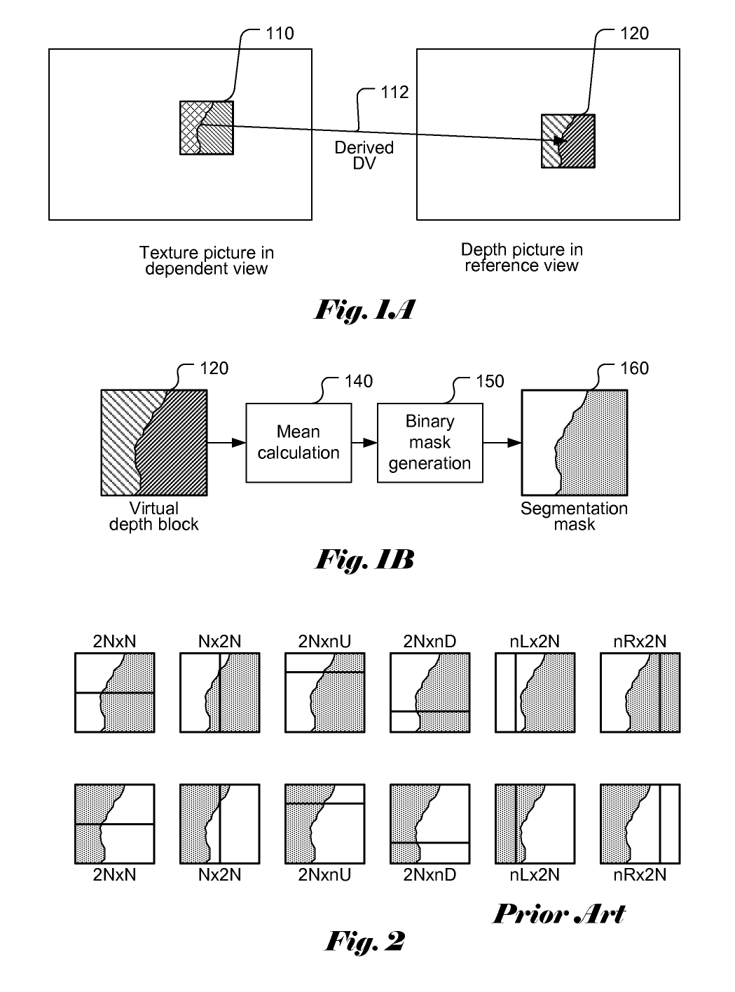

### DETAILED DESCRIPTION OF THE INVENTION

In order to overcome the computational complexity issues associated with existing depth-based block partitioning (DBBP) process, the present invention discloses various embodiments to reduce the complexity and/or memory access.

In one embodiment, the depth-based block partitioning (DBBP) process uses a partial set of full partition candidates. In other words, the number of candidates in the selected set may be less than the number of candidates in a full set. The selected set of block partition candidates can be explicitly signaled in VPS (video parameter set), SPS (sequence parameter set), PPS (picture parameter set), Slice header, CTU (Coding Tree Unit), CTB (Coding Tree Block), CU (coding unit), PU (prediction unit) or TU (transform unit) level of bitstream. The selected set of block partition can be selected from multiple sets of pre-specified or pre-defined sets. In this case, an indication will be signaled to identify the set selected among the multiple sets. For example, an index may be associated with each set and the index may be signaled explicated or derived implicitly. Alternatively, various means to represent the partial candidates can be used. For example, a significant map can be used to identify the particular candidates selected for the set. In the case the full partition map consisting of 6 bits may be used, where each bit corresponds to one candidate. If the candidate belongs to the selected set, the corresponding bit may have a value of 1. Otherwise, the corresponding bit has a value of 0. While the significant map is illustrated as an example of partition candidate representation, other means, such as significant table or a set of significant flags may also be used.

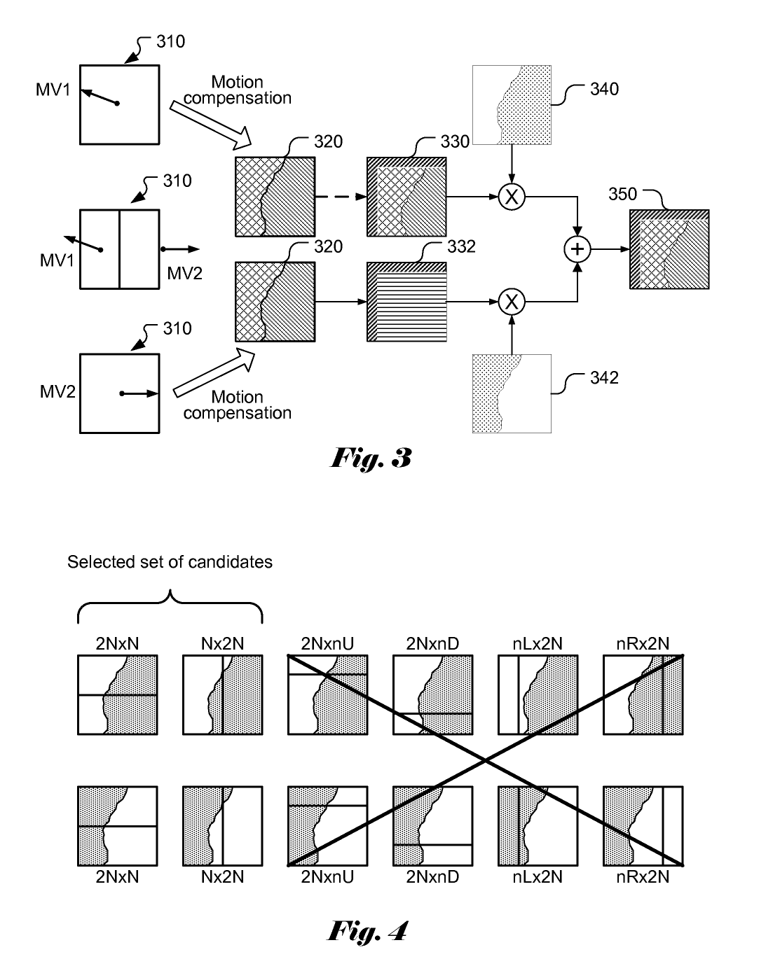

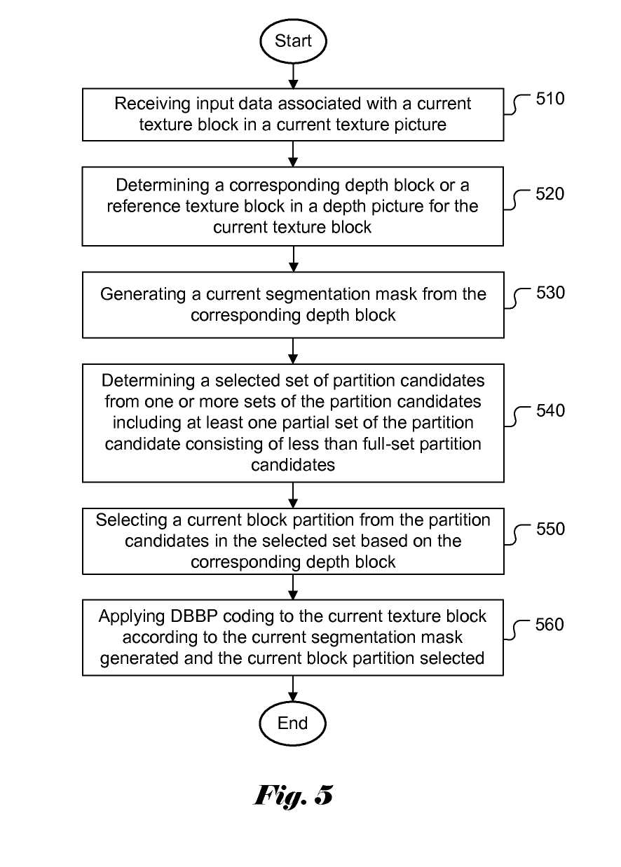

The selected set of block partition candidates can also be derived implicitly. A set of candidates can be selected from multiple sets corresponding to pre-specified subsets of full partition candidates without signaling if the encoder and decoder use a same derivation process. If there is only one set of candidates and the set of candidates is pre-defined at the decoder, there is no need to signal the selection. For example, the partition candidates may correspond to a set with all AMP partition candidates excluded from the full candidates, as shown in FIG. 4. If this is the only set of candidates to select, there is no need to signal the selected set of candidates. In this case, after sub-sample level mean value calculation and pixel-by-pixel CU segmentation mask derivation, the partition selection only needs to evaluate (i.e., counting the matched samples) for partition candidates corresponding to 2N×N and N×2N partitions.

The selected set of partition candidates may also depend on the size of the current block. For example, the selected set of partition candidates may exclude any partition candidate from 2N×nU, 2N×nD, nL×2N and nR×2N partition candidates if the current block size belongs to a set of allowed block sizes. The set of allowed block sizes can be signaled using a significant map, a significant table or significant flags in VPS (video parameter set), SPS (sequence parameter set), PPS (picture parameter set), Slice header, CTU (Coding Tree Unit), CTB (Coding Tree Block), CU (coding unit), PU (prediction unit) or TU (transform unit) level of bitstream. The set of allowed block sizes can be pre-defined and there is no need to signal the block size set explicitly.

According to another embodiment of the present invention, the DBBP process will be applied to a current block depending on the current block size (i.e., a CU size). In other words, the DBBP process will be applied only if the block size belongs to a set of allowed block sizes. The information on block size limitation can be signaled explicitly in VPS (video parameter set), SPS (sequence parameter set), PPS (picture parameter set), Slice header, CTU (Coding Tree Unit), CTB (Coding Tree Block), CU (coding unit), PU (prediction unit) or TU (transform unit) level of bitstream. Alternatively, information regarding the block size limitation can be determined implicitly at the decoder side without any transmitted information. The allowed block sizes can be a pre-specified or predefined subset containing one or more predefined CU sizes. For example, the set of allowed block sizes may correspond to N×N block, where N is greater than a positive integer M. The set selection of M can be signaled in the bitstream explicitly or derived implicitly without signaling. For example, for each video sequence, the allowed block size can be any size larger than 8×8 in order to utilize the DBBP mode. The encoder and decoder may also use the same procedure to select the set of allowed block size based on neighboring blocks to avoid the need to explicit signaling. The set of allowed block sizes can be represented using a significant map, a significant table or significant flags.

FIG. 5 illustrates a flowchart of an exemplary system incorporating an embodiment of the present invention to simplify depth-based block partitioning (DBBP), where at least one set of partition candidates consists of only partial partition candidates. The system receives input data associated with a current texture block in a current texture picture as shown in step 510. For encoding, the input data corresponds to pixel data to be encoded. For decoding, the input data corresponds to coded pixel data to be decoded. The input data may be retrieved from memory (e.g., computer memory, buffer (RAM or DRAM) or other media) or from a processor. A corresponding depth block in a depth picture is determined for the current texture block in step 520. A current segmentation mask is generated from the corresponding depth block in step 530. A selected set of partition candidates is determined from one or more sets of the partition candidates including at least one partial set of the partition candidate consisting of less than full-set partition candidates in step 540. A current block partition is generated from the partition candidates in the selected set based on the corresponding depth block in step 550. DBBP coding is then applied to the current texture block according to the current segmentation mask generated and the current block partition selected in step 560.

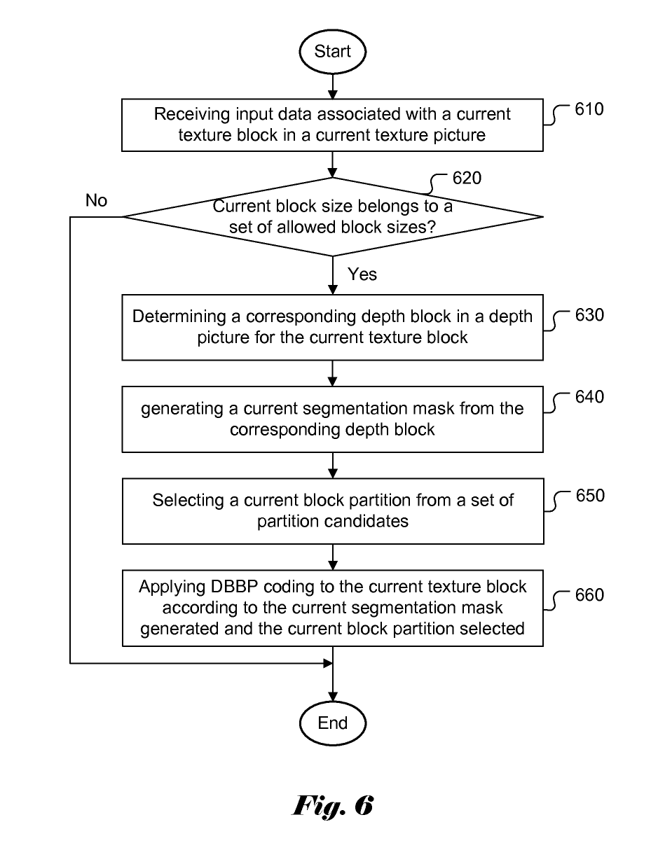

FIG. 6 illustrates a flowchart of an exemplary system incorporating an embodiment of the present invention to simplify depth-based block partitioning (DBBP), where the depth-based block partitioning coding is applied to a current texture block only if the current block size belongs to a set of allowed block sizes. The system receives input data associated with a current texture block in a current texture picture as shown in step 610. The current block size is checked to determine whether it belongs to a set of allowed block sizes in step 620. If it belongs to a set of allowed block sizes (i.e., the yes path), the steps from 630 to 660 are performed. In step 630, a corresponding depth block in a depth picture is determined for the current texture block. In step 640, a current segmentation mask is generated from the corresponding depth block. In step 650, a current block partition is selected from a set of partition candidates. In step 660, DBBP coding is applied to the current texture block according to the current segmentation mask generated and the current block partition selected. If the current block size doesn't belong to a set of allowed block sizes (i.e., the No path), the steps from 630 to 660 are skipped.

The flowcharts shown above are intended to illustrate examples of simplified depth-based block partitioning (DBBP) according to the present invention. A person skilled in the art may modify each step, re-arranges the steps, split a step, or combine steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of simplified depth-based block partitioning (DBBP) for multi-view video coding or three-dimensional (3D) video coding, the method comprising:
receiving input data associated with a current texture block in a current texture picture;
determining a corresponding depth block in a depth picture for the current texture block;
generating a current segmentation mask from the corresponding depth block;
determining a selected set of partition candidates from one or more sets of the partition candidates including at least one partial set of the partition candidate consisting of less than full-set partition candidates;
selecting a current block partition from the partition candidates in the selected set based on the corresponding depth block; and
applying DBBP coding to the current texture block according to the current segmentation mask generated and the current block partition selected.

2. The method of claim 1, wherein the full-set partition candidates consist of 2N×N, N×2N, 2N×nU, 2N×nD, nL×2N and nR×2N block partitions.

3. The method of claim 1, wherein said one or more sets of the partition candidates correspond to one simplified set consisting of 2N×N and N×2N block partitions and there is no need to signal the selected set of partition candidates.

4. The method of claim 1, wherein said one or more sets of the partition candidates comprise one simplified set consisting of 2N×N and N×2N block partitions.

5. The method of claim 1, wherein said one or more sets of the partition candidates are pre-defined and each of said one or more sets is indicated by an index.

6. The method of claim 5, wherein the index for the selected set is signaled explicitly in VPS (video parameter set), SPS (sequence parameter set), PPS (picture parameter set), Slice header, CTU (Coding Tree Unit), CTB (Coding Tree Block), CU (coding unit), PU (prediction unit) or TU (transform unit) level of bitstream.

7. The method of claim 1, wherein the selected set of partition candidates is signaled explicitly in VPS (video parameter set), SPS (sequence parameter set), PPS (picture parameter set), Slice header, CTU (Coding Tree Unit), CTB (Coding Tree Block), CU (coding unit), PU (prediction unit) or TU (transform unit) level of bitstream.

8. The method of claim 7, wherein the selected set of partition candidates is represented using a significant map, a significant table or significant flags.

9. The method of claim 1, wherein the selected set of partition candidates excludes any partition candidate from 2N×nU, 2N×nD, nL×2N and nR×2N partition candidates if a current block size belongs to a set of allowed block sizes.

10. The method of claim 9, wherein the set of allowed block sizes is signaled using a significant map, a significant table or significant flags in VPS (video parameter set), SPS (sequence parameter set), PPS (picture parameter set), Slice header, CTU (Coding Tree Unit), CTB (Coding Tree Block), CU (coding unit), PU (prediction unit) or TU (transform unit) level of bitstream.

11. The method of claim 9, wherein the set of allowed block sizes is pre-defined and there is no need to signal the block size set explicitly.

12. A method of simplified depth-based block partitioning (DBBP) for multi-view video coding or three-dimensional (3D) video coding, the method comprising:
receiving input data associated with a current texture block in a current texture picture;
determining whether current block size belongs to a set of allowed block sizes;
if the current block size belongs to the set of allowed block sizes:
determining a corresponding depth block in a depth picture for the current texture block;
generating a current segmentation mask from the corresponding depth block;
selecting a current block partition from a set of partition candidates; and
applying DBBP coding to the current texture block according to the current segmentation mask generated and the current block partition selected.

13. The method of claim 12, wherein the set of allowed block sizes is pre-defined and no explicit signaled is needed.

14. The method of claim 12, wherein the set of allowed block sizes is signaled explicitly in VPS (video parameter set), SPS (sequence parameter set), PPS (picture parameter set), Slice header, CTU (Coding Tree Unit), CTB (Coding Tree Block), CU (coding unit), PU (prediction unit) or TU (transform unit) level of bitstream.

15. The method of claim 14, wherein the set of allowed block sizes is represented using a significant map, a significant table or significant flags.

16. The method of claim 14, wherein the set of allowed block sizes consists of all N×N block sizes, wherein N is greater than a positive integer M.

17. The method of claim 16, wherein the N is signaled explicitly or is pre-defined.

18. The method of claim 16, wherein the M corresponds to 8.
